(19) United States
(12) Patent Application Publication
(10) Pub. No.: US 2022/0027758 A1
(43) Pub. Date: Jan. 27, 2022

(54) INFORMATION PROCESSING APPARATUS AND INFORMATION PROCESSING METHOD

(71) Applicant: FUJITSU LIMITED, Kawasaki-shi (JP)

(72) Inventors: Enxhi Kreshpa, Kawasaki (JP); Shigeto SUZUKI, Kawasaki (JP); Yasufumi Sakai, Fuchu (JP); Takashi Shiraishi, Atsugi (JP); Takuji YAMAMOTO, Hachiouji (JP)

(73) Assignee: FUJITSU LIMITED, Kawasaki-shi (JP)

(21) Appl. No.: 17/228,532

(22) Filed: Apr. 12, 2021

(30) Foreign Application Priority Data
Jul. 27, 2020 (JP) 2020-126357

(51) Int. Cl. G06N 5/04; G06F 9/48; G06F 1/329; G06N 20/00

(52) U.S. Cl. CPC G06N 5/04; G06N 20/00; G06F 1/329; G06F 9/4893

(57) ABSTRACT

First clustering is performed on a plurality of samples each including time-series measurement values of power consumption to thereby generate a plurality of first clusters. The plurality of first clusters are each classified as a second cluster satisfying a determination condition or a third cluster that does not satisfy the determination condition. The determination condition includes at least one of a first criterion in which the variance of correlation values between samples is less than a first threshold and a second criterion in which the average of the correlation values exceeds a second threshold. Second clustering is performed on samples included in the third cluster to divide the third cluster into a plurality of fourth clusters. Training data for use in generation of a model for predicting power consumption is generated based on the second cluster and at least one of the fourth clusters.

### CROSS-REFERENCE TO RELATED APPLICATION

This application is based upon and claims the benefit of priority of the prior Japanese Patent Application No. 2020-126357, filed on Jul. 27, 2020, the entire contents of which are incorporated herein by reference.

### FIELD

The embodiments discussed herein relate to an information processing apparatus and an information processing method.

### BACKGROUND

A large-scale information processing system such as a high performance computing (HPC) system may consume a very large amount of power as a whole. Therefore, the large-scale information processing system has an operating policy in which the total power consumption per unit time does not exceed a threshold, in view of an operating cost and environmental loads. The large-scale information processing system performs a plurality of jobs in parallel. Since the plurality of jobs may have different resource usage patterns such as processor usage, access frequency to storage, communication frequency, and others, these jobs may consume different amounts of power per unit time.

In view of the above, the large-scale information processing system may predict the power consumption of the individual jobs and calculate the sum of the predicted power consumption of the jobs to thereby predict the total power consumption. If it is expected that, at this rate, the total power consumption would exceed the threshold, the large-scale information processing system performs job scheduling with taking the power consumption into account. For example, the large-scale information processing system may suspend some of the jobs that have high power consumption.

By the way, there has been proposed a prediction apparatus that predicts the amount of photovoltaic power generation using a neural network. This proposed prediction apparatus divides training data into a plurality of clusters and generates a neural network for each cluster through machine learning. When receiving input data, the prediction apparatus specifies a cluster that most approximates the input data and predicts the amount of power generation using the neural network corresponding to the specified cluster.

Further, there has been proposed a job scheduler that controls the upper limit of power consumption of each job executed by an HPC system and the processor frequencies of nodes used by each job so that the total power consumption of the HPC system does not exceed a reference amount. Still further, there has been proposed a management apparatus that presumes the type of a process performed by a machine. This proposed management apparatus obtains time-series data indicating temporal changes in the power consumption of the machine and classifies the time-series data into one of a plurality of classes. The management apparatus then presumes the type of a process performed by the machine according to the class to which the time-series data belongs.

Please see, for example, Japanese Laid-open Patent Publication No. 2013-74695.

International Publication Pamphlet No. WO 2016/028371.

International Publication Pamphlet No. 2019/167676.

A method is considered, which predicts the power consumption of jobs using a model generated by machine learning, such as a multilayer neural network generated by deep learning. Here, in performing the machine learning for generating a power consumption prediction model, it is conceivable to use, as training data, samples indicating temporal changes in the power consumption of jobs executed in the past.

Note that a large number of samples are collected from a large-scale information processing system, and these samples may include samples that indicate similar power consumption patterns. For this reason, the use of all the collected samples is not efficient. To deal with this, the following method may be considered: clustering is performed on the set of samples, and the size of the training data is reduced on the basis of the clustering result. However, a general clustering algorithm such as the k-means algorithm may fail to achieve high accuracy of classifying the samples indicating temporal changes in power consumption. As a result, the training data may have questionable quality, and the power consumption prediction model generated from the training data may have low prediction accuracy.

### SUMMARY

According to one aspect, there is provided an information processing apparatus including: a memory that stores therein a plurality of samples each including time-series measurement values of power consumption; and a processor configured to perform a process including performing first clustering on the plurality of samples to generate a plurality of first clusters each including two or more samples, classifying each of the plurality of first clusters as a second cluster satisfying a determination condition or a third cluster that does not satisfy the determination condition, the determination condition including at least one of a first criterion in which a variance of correlation values between the two or more samples is less than a first threshold and a second criterion in which an average of the correlation values exceeds a second threshold, performing second clustering on the two or more samples included in the third cluster to divide the third cluster into a plurality of fourth clusters, and generating training data, based on the second cluster and at least one of the plurality of fourth clusters, the training data being used for generating a model for predicting the power consumption.

### BRIEF DESCRIPTION OF DRAWINGS

FIG. 1 is a view for explaining an information processing apparatus according to a first embodiment;

FIG. 2 illustrates an example of an information processing system according to a second embodiment;

FIG. 3 is a block diagram illustrating an example of hardware configuration of a machine learning apparatus;

FIG. 4 is a graph representing the prediction and actual measurement of power consumption of a job;

FIG. 5 illustrates an example of prediction of power consumption by a model;

FIG. 6 illustrates an example of reducing training data by clustering;

FIG. 7 illustrates an example of subdividing an unfavorable cluster;

FIG. 8 illustrates an example of generating training data;

FIG. 9 illustrates an example of a correlation table;

FIG. 10 is a graph representing an example of classification of clusters based on the standard deviation of correlation values;

FIG. 11 is a graph representing an example of classification of clusters based on the average of correlation values;

FIG. 12 is a block diagram illustrating an example of functions of the machine learning apparatus;

FIG. 13 illustrates an example of a power consumption table;

FIG. 14 is a flowchart illustrating an example of a procedure of machine learning; and

FIG. 15 is a flowchart illustrating an example of a procedure of generating training data.

### DESCRIPTION OF EMBODIMENTS

Some embodiments will be described with reference to the accompanying drawings.

### First Embodiment

A first embodiment will be described.

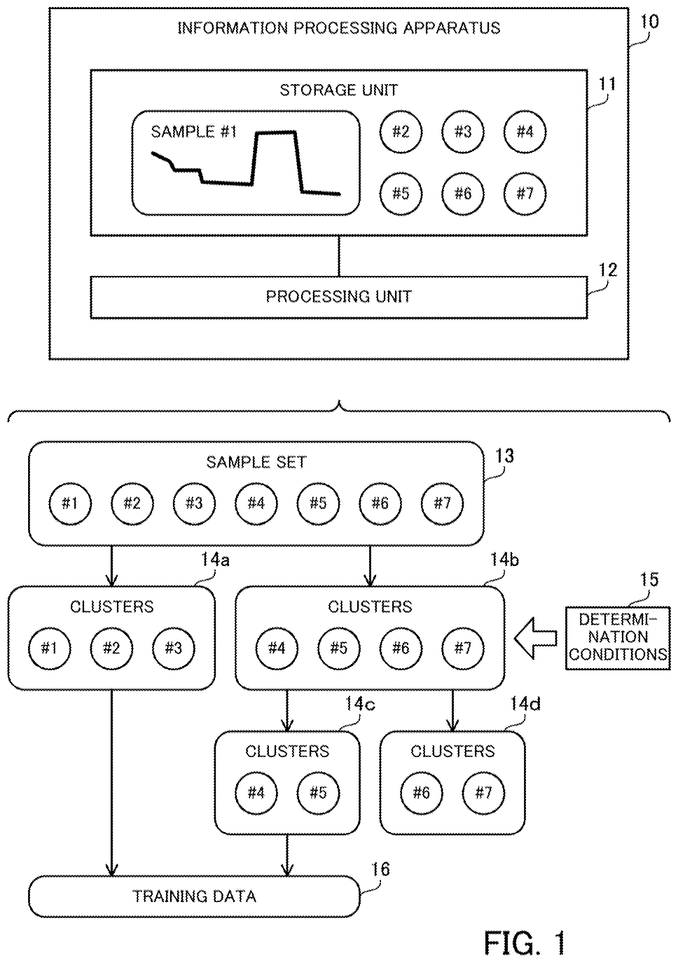

FIG. 1 is a view for explaining an information processing apparatus according to the first embodiment.

The information processing apparatus 10 of the first embodiment generates training data for use in machine learning. The information processing apparatus 10 may perform the machine learning using the training data to generate a model. Then, the information processing apparatus 10 may perform prediction using the generated model. Here, a model for predicting power consumption is generated by the machine learning.

The model may be a multilayer neural network that is generated by deep learning. The generated model may be a model for predicting the power consumption of jobs that are executed in a large-scale information processing system such as an HPC system. The generated model may be used for job scheduling of the large-scale information processing system. The generated model may be a model for predicting future power consumption from actual power consumption obtained during an immediately preceding period. The information processing apparatus 10 may be a client apparatus or a server apparatus. The information processing apparatus 10 may be called a computer or a machine learning apparatus.

The information processing apparatus 10 includes a storage unit 11 and a processing unit 12. The storage unit 11 may be a volatile semiconductor memory such as a random access memory (RAM) or a non-volatile storage device such as a hard disk drive (HDD) or a flash memory. For example, the processing unit 12 is a processor such as a central processing unit (CPU), a graphics processing unit (GPU), or a digital signal processor (DSP). The processing unit 12 may include an application specific integrated circuit (ASIC), a field programmable gate array (FPGA), or another application-specific electronic circuit. The processor executes a program stored in a memory such as a RAM (e.g., the storage unit 11). A set of multiple processors may be called “a multiprocessor” or simply “a processor.”

The storage unit 11 stores therein a sample set 13 including a plurality of samples. Each sample includes time-series measurement values of power consumption. A sample may be called a power consumption signal. For example, each sample is a sequence of measurement values of power consumption measured every five minutes. For example, different samples indicate the power consumption of different jobs executed in the past in the HPC system. For example, the power consumption of a job is average power consumption per computing node used for the job. The power consumption of a job is affected by resource usage patterns such as processor usage, access frequency to storage, communication frequency, and others. Thus, the power consumption depends on the content of computation.

The processing unit 12 generates training data 16 from the sample set 13. First, the processing unit 12 performs first clustering on the sample set 13. For the first clustering, a variety of clustering algorithms including the k-means algorithm and the Gaussian mixture model (GMM) algorithm may be used. The processing unit 12 performs the first clustering to generate a plurality of first clusters each including two or more samples. For example, the processing unit. 12 generates clusters 14a and 14b. The cluster 14a includes samples #1, #2, and #3, and the cluster 14b includes samples #4, #5, #6, and #7.

Then, the processing unit 12 classifies each of the plurality of first clusters as a second cluster satisfying determination conditions 15 or a third cluster that does not satisfy the determination conditions 15. The determination conditions 15 include either or both of a variance criterion and an average criterion. The determination conditions 15 may be satisfaction of the variance criterion or average criterion (OR condition) or may be satisfaction of the variance criterion and average criterion (AND condition). The variance criterion is that the variance of the correlation values between the samples of the same cluster is less than a first threshold. The average criterion is that the average of the correlation values between the samples of the same cluster exceeds a second threshold.

For example, with respect to each of the plurality of first clusters, correlation values are exhaustively calculated for all possible pairs of samples within the cluster. A correlation value is an index value indicating a correlation between two samples. For example, a correlation value represents the cross-correlation between two time-series measurement values. A higher correlation value between two samples indicates a higher similarity therebetween, meaning that these samples represent similar temporal changes in power consumption. On the other hand, a lower correlation value between two samples indicates a lower similarity therebetween, meaning that these samples represent dissimilar temporal changes in power consumption.

The thresholds for the variance and average may be fixed values or may be specified by a user. In addition, the threshold for the variance may relatively be determined based on the distribution of variances calculated for the plurality of first clusters. Similarly, the threshold for the average may relatively be determined based on the distribution of averages calculated for the plurality of first clusters. In this connection, the “variance” may mean a variance in the narrow sense on the statistical theory or may be represented by another index indicating the width of a distribution such as a standard deviation.

For example, the cluster 14a satisfies the determination conditions 15 and the cluster 14b does not satisfy the determination conditions 15. In this case, the processing unit 12 classifies the cluster 14a as a second cluster and the cluster 14b as a third cluster. In the cluster 14a, the samples #1, #2, and #3 have similar time-series measurement values. On the other hand, in the cluster 14b, the samples #4, #5, #6, and #7 are not said to have similar time-series measurement values. The second cluster may be called a favorable cluster, whereas the third cluster may be called an unfavorable cluster.

After that, the processing unit 12 performs second clustering on the third clusters. For the second clustering, a clustering algorithm that is the same as or different from that used in the first clustering may be used. Through the second clustering, the processing unit 12 divides each third cluster into a plurality of fourth clusters. For example, the processing unit 12 divides the cluster 14b into clusters 14c and 14d. The cluster 14c includes samples #4 and #5, and the cluster 14d includes samples #6 and #7.

The samples #4 and #5 belonging to the cluster 14c are expected to have a high similarity therebetween. Therefore, it is expected that the variance of correlation values of the cluster 14c is lower than that of the cluster 14b and the average of the correlation values of the cluster 14c is higher than that of the cluster 14b. Similarly, the samples #6 and #7 belonging to the cluster 14d are expected to have a high similarity therebetween. Therefore, it is expected that the variance of correlation values of the cluster 14d is lower than that of the cluster 14b and the average of the correlation values of the cluster 14d is higher than that of the cluster 14b.

Then, the processing unit 12 generates training data 16 using the second clusters generated by the first clustering and at least one of the plurality of fourth clusters generated by the second clustering. At this time, the processing unit 12 may use fourth clusters satisfying the determination conditions 15 among the plurality of fourth clusters. For example, the processing unit 12 generates the training data 16 on the basis of the clusters 14a and 14c. The training data 16 is used in machine learning that generates a model for predicting power consumption.

In the generation of the training data 16, for example, the processing unit 12 extracts representative samples from applicable clusters. One representative sample may be extracted from each cluster. The representative sample of each applicable cluster represents the tendency of temporal changes in the power consumption represented by the two or more samples belonging to the cluster and approximates the two or more samples. The representative sample may be one of the two or more samples belonging to the applicable cluster or a new sample generated from the two or more samples.

The representative sample may be called the center of mass of the cluster. For example, the representative sample may be the average of the two or more samples included in the applicable cluster or may be the center of the distribution of the cluster. In this case, the representative sample includes the measurement vales of the individual time points that are each the average of the measurement values of a corresponding time point included in the two or more samples. Alternatively, the representative sample may be a sample closest to the average among the two or more samples included in the applicable cluster or may be a sample closest to the center of the distribution of the cluster.

The processing unit 12 adds the extracted representative samples to the training data 16, for example. The training data 16 may include only the representative samples extracted in the way described above. The size (the number of samples) of the training data 16 is expected to be smaller than that of the sample set 13.

With the information processing apparatus 10 of the first embodiment, the first-stage clustering is performed on the sample set 13. A plurality of clusters generated as a result of the first-stage clustering are each classified as a favorable cluster with a narrow distribution of samples or an unfavorable cluster with a wide distribution of samples on the basis of the correlations between the samples. The second-stage clustering is performed on the unfavorable clusters to subdivide each unfavorable cluster into a plurality of clusters. Then, the training data 16 is generated using the results of the first-stage clustering and second-stage clustering.

If the second-stage clustering is not performed, unfavorable clusters with a wide distribution of samples would be used. For example, from an unfavorable cluster, an inappropriate representative sample, which does not approximate the samples belonging to the unfavorable cluster, would be extracted. As a result, training data 16 would have questionable quality, and a model generated from the training data 16 would have low prediction accuracy. By contrast, the second-stage clustering improves the quality of the training data 16 and accordingly improves the prediction accuracy of a model generated from the training data 16.

### Second Embodiment

A second embodiment will now be described.

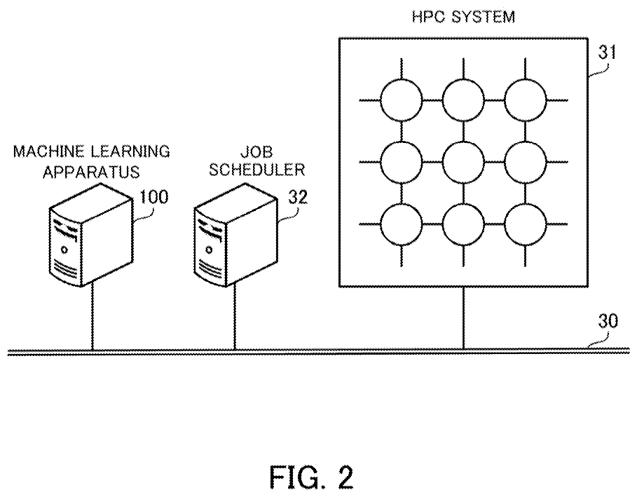

FIG. 2 illustrates an example of an information processing system according to the second embodiment.

The information processing system of the second embodiment includes an HPC system 31, a job scheduler 32, and a machine learning apparatus 100. The HPC system 31, job scheduler 32, and machine learning apparatus 100 are connected to a network 30. The network 30 may include a local network such as a local area network (LAN) or a wide-area network such as the Internet.

The HPC system 31 is a large-scale information processing system with a large number of computing resources. The HPC system 31 performs a plurality of jobs in parallel in accordance with a schedule specified by the job scheduler 32. The HPC system 31 includes a plurality of computing nodes that are computers. Each computing node has a processor, a memory, and a communication interface and executes a program. The plurality of computing nodes are mutually connected over a network. The network is an interconnect network in a mesh or torus topology, for example.

Each job includes one or more processes. The one or more processes are initiated according to a program created by a user. In the case where a job includes two or more processes, these two or more processes are executed in parallel by different computing nodes. That is, one job uses one or more computing nodes. The number of computing nodes used for a job is specified by the user. In the HPC system 31, sensor devices for measuring power consumption are provided inside or outside the computing nodes. The power consumption varies due to the use of hardware components including processors, memories, communication interfaces, and others. The HPC system 31 continuously measures the power consumption of the individual computing nodes (for example, every five minutes), and reports the measurement values of the power consumption to the job scheduler 32.

The job scheduler 32 is a server computer that performs job scheduling. The job scheduler 32 receives a job execution request from the user. The job scheduler 32 assigns each job to computing nodes of the HPC system 31 and instructs the HPC system 31 to execute the programs of the jobs. In the case where it is not possible to perform all of the jobs in parallel due to lack of the computing 1) nodes, the job scheduler 32 determines an order of execution of the plurality of jobs so as to cause some of the jobs to wait. By doing so, these jobs are executed at a later time.

In addition, the job scheduler 32 performs the job scheduling with taking the power consumption into account such that the total power consumption of the HPC system 31 does not exceed a contract demand. The job scheduler 32 obtains a power consumption prediction model from the machine learning apparatus 100. In addition, the job scheduler 32 collects power consumption information from the HPC system 31 and calculates the power consumption of each job under execution. As the power consumption of a job, average power consumption per computing node is calculated. The job scheduler 32 inputs the power consumption of the jobs obtained so far to the power consumption prediction model and predicts future power consumption (for example, for 30 minutes from the present time).

The job scheduler 32 predicts future total power consumption of the HPC system 31 on the basis of the predicted values of power consumption of the individual jobs. In the case where the predicted value of the total power consumption exceeds the contract demand, the job scheduler 32 takes countermeasures so that the total power consumption does not reach the contract demand. For example, the job scheduler 32 suspends some of the jobs. For example, the job scheduler 32 stops some of the jobs for 30 minutes. For example, jobs that consume a large amount of power are suspended.

The machine learning apparatus 100 is a computer that generates the power consumption prediction model with machine learning. The machine learning apparatus 100 may be a client apparatus or a server apparatus. The machine learning apparatus 100 corresponds to the information processing apparatus 10 of the first embodiment. The machine learning apparatus 100 collects samples indicating temporal changes in the power consumption of jobs executed in the past, from the job scheduler 32. The machine learning apparatus 100 generates training data from the collected samples and generates the power consumption prediction model using the training data.

The power consumption prediction model of the second embodiment is a multilayer neural network. The power consumption prediction model receives a sequence of measurement values of power consumption as input data and outputs a sequence of predicted values of power consumption as output data. The machine learning apparatus 100 supplies the generated power consumption prediction model to the job scheduler 32.

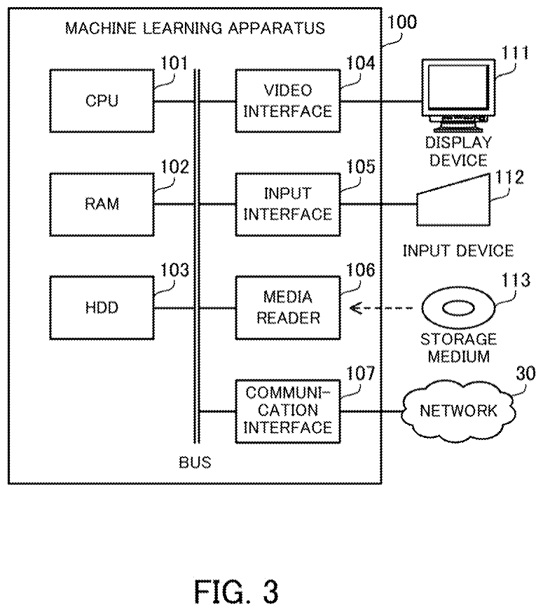

FIG. 3 is a block diagram illustrating an example of hardware configuration of the machine learning apparatus.

The machine learning apparatus 100 includes a CPU 101, a RAM 102, an HDD 103, a video interface 104, an input interface 105, a media reader 106, and a communication interface 107. These units provided in the machine learning apparatus 100 are connected to a bus. The CPU 101 corresponds to the processing unit 12 of the first embodiment. The RAM 102 or HDD 103 corresponds to the storage unit 11 of the first embodiment. The nodes and job scheduler 32 provided in the HPC system 31 may be implemented with the same hardware components.

The CPU 101 is a processor that executes program commands. The CPU 101 loads at least part of a program or data from the HDD 103 to the RAM 102 and executes the program. The CPU 101 may be provided with a plurality of processor cores, and the machine learning apparatus 100 may be provided with a plurality of processors. A set of multiple processors may be called “a multiprocessor,” or simply “a processor.”

The RAM 102 is a volatile semiconductor memory that temporarily stores therein a program executed by the CPU 101 and data used by the CPU 101 in processing. The machine learning apparatus 100 may include a different kind of memory than a RAM or a plurality of memories.

The HDD 103 is a non-volatile storage device that stores therein software programs such as an operating system (OS), middleware, and application software, and data. The machine learning apparatus 100 may include a different kind of storage device such as a flash memory or a solid state drive (SSD) or a plurality of storage devices.

The video interface 104 outputs images to a display device 111 connected to the machine learning apparatus 100 in accordance with commands from the CPU 101. Any kind of display device such as a cathode ray tube (CRT) display, a liquid crystal display (LCD), an organic electro-luminescence (OEL) display, or a projector may be used as the display device 111. Other than the display device 111, an output device such as a printer may be connected to the machine learning apparatus 100.

The input interface 105 receives an input signal from an input device 112 connected to the machine learning apparatus 100. Any kind of input device such as a mouse, a touch panel, a touchpad, or a keyboard may be used as the input device 112. A plurality of kinds of input devices may be connected to the machine learning apparatus 100.

The media reader 106 is a reading device that reads a program or data from a storage medium 113. Any kind of storage medium, i.e., a magnetic disk such as a flexible disk (FD) or an HDD, an optical disc such as a compact disc (CD) or a digital versatile disc (DVD), or a semiconductor memory may be used as the storage medium 113. For example, the media reader 106 copies, for example, a program or data read from the storage medium 113 to another storage medium such as the RAM 102 or the HDD 103. The read program is executed by the CPU 101, for example. The storage medium 113 may be a portable storage medium and may be used to distribute a program or data. In addition, the storage medium 113 and HDD 103 may be referred to as computer-readable storage media.

The communication interface 107 is connected to the network 30 and communicates with the job scheduler 32 over the network 30. The communication interface 107 may be a wired communication interface connected to a wired communication apparatus such as a switch or a router or may be a wireless communication interface connected to a wireless communication apparatus such as a base station or an access point.

The following describes prediction of power consumption of a job.

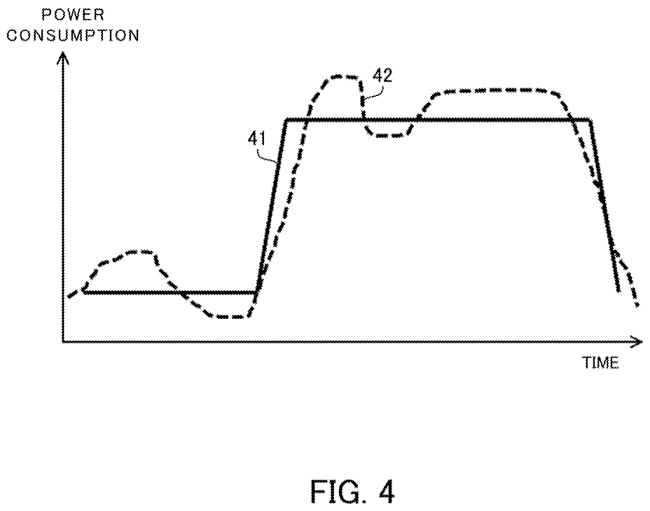

FIG. 4 is a graph representing the prediction and actual measurement of power consumption of a job.

A curve 41 is a power consumption signal representing the actual measurement of power consumption of a job. A curve 42 is a power consumption signal representing the prediction of power consumption calculated by a power consumption prediction model. The power consumption represented by each curve 41 and 42 is average power consumption per computing node used for the job, for example. The total power consumption of the job is obtained by multiplying the power consumption represented by the curve 41 or 42 by the number of computing nodes, for example. The actual measurement of power consumption is obtained every five minutes. Therefore, the curve 41 is represented by a sequence of measurement values at five-minute intervals. In addition, the prediction of power consumption for every five minutes is calculated. Therefore, the curve 42 is represented by a sequence of predicted values at five-minute intervals. The jobs for which the power consumption is predicted take 35 minutes at least and 1440 minutes (24 hours) at most. Therefore, each job has seven measurement values of power consumption at least and 288 measurement values at most.

The accuracy of the power consumption prediction model is evaluated on the basis of the error between the actual measurement of power consumption represented by the curve 41 and the prediction of power consumption represented by the curve 42. For example, as an index of the error, root mean squared error (RMSE) is used. An RMSE is calculated for each job. In the case where the prediction is made for n jobs, the accuracy of the power consumption prediction model is evaluated using the overall RMSE that is the average RMSE of the n jobs. A lower overall RMSE indicates a high accuracy of the model, whereas a higher overall RMSE indicates a lower accuracy of the model.

The overall RMSE is calculated by the equation (1), where n denotes the number of jobs, j denotes a job number, T denotes the number of measurement points (measurement time points), t denotes a measurement point number, y denotes a measurement value of power consumption, and y\hat{ } denotes a predicted value of power consumption. For example, T has a value of 288.

$${RMSE}_{total} = \frac{1}{n} {\sum }_{j = 1}^{n} {RMSE}_{j} = \frac{1}{n} {\sum }_{j = 1}^{n} \sqrt{\frac{{\sum }_{t = 1}^{T} {( {\hat{y}}_{j , t} - {y}_{j , t} )}^{2}}{T}} \qquad ( 1 )$$

The owner of the HPC system 31 has a big power supply contract with a power company. A contract demand is set in the big power supply contract. The power company calculates the average power consumption of the HPC system 31 every 30 minutes. In principle, the power company charges the owner of the HPC system 31 a fixed electricity fee. However, if the average power consumption over 30 minutes exceeds the contract demand, a high additional fee incurs as a penalty. To reduce the operating cost of the HPC system 31, the job scheduler 32 performs job scheduling so that the power consumption does not exceed the contract demand.

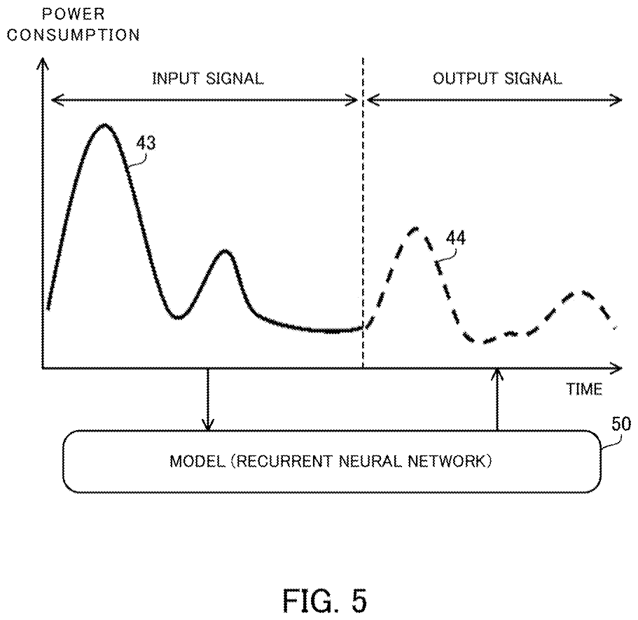

FIG. 5 illustrates an example of prediction of power consumption by a model.

A model 50 is a power consumption prediction model generated by the machine learning apparatus 100. As the model 50, a recurrent neural network (RNN) is used. The recurrent neural network receives time-series measurement values and outputs time-series predicted value. The recurrent neural network has a feedback path that leads from a node close to an output back to a node close to an input. This allows the recurrent neural network to hold the internal state. Because of the presence of the internal state, the output at time t depends not only on the input at time t but also on the inputs on or before the time t−1. Examples of the recurrent neural network are a long short-term memory (LSTM) and a gated recurrent unit (GRU).

In the use phase of the model 50, a sequence of measurement values of power consumption obtained so far for a job under execution is input to the model 50. The model 50 then outputs a sequence of predicted values of future power consumption for the job under execution. The curve 43 is an input signal representing time-series measurement values of power consumption. The curve 44 is an output signal representing time-series predicted values of power consumption. For example, the model 50 receives the time-series measurement values taken during a period of 30 minutes or longer, that is, six or more measurement values. The model 50 may receive all measurement values from the start of execution of the job up to the present or may receive only measurement values taken during the last 30 minutes. Then, the model 50 outputs the time-series predicted values for a period of 30 minutes following the input period, that is, six predicted values.

In the learning phase of the model 50, samples including time-series measurement values corresponding to the curve 43 and time-series measurement values corresponding to the curve 44 are collected. In the machine learning, the time-series measurement values corresponding to the curve 43 are used as input data and the time-series measurement values corresponding to the curve 44 are used as teaching data. With error backpropagation, the values of parameters included in the model 50 are optimized using the collected samples.

The machine learning apparatus 100 inputs time-series measurement values taken during a period of 30 minutes or longer included in the samples, i.e., six or more measurement values to the model 50. The model 50 outputs time-series predicted values for a period of 30 minutes following the input period, that is, six predicted values. The machine learning apparatus 100 calculates the errors between the time-series predicted values output from the model 50 and the time-series measurement values taken for the period of 30 minutes following the input period included in samples. The machine learning apparatus 100 then updates the values of the parameters included in the model 50 so as to reduce the errors.

The following describes training data that is used in generation of the power consumption prediction model. Since the HPC system 31 executes a large number of jobs, a large number of samples indicating temporal changes in the power consumption of the jobs are collected from the HPC system 31. Note that the large number of samples include samples indicating similar temporal changes in power consumption. Therefore, if all the samples collected from the HPC system 31 are used as training data, the training data has redundancy and is very large in size. This unnecessarily increases the execution time of the machine learning, and thus the machine learning becomes inefficient. To deal with this, the machine learning apparatus 100 reduces the training data.

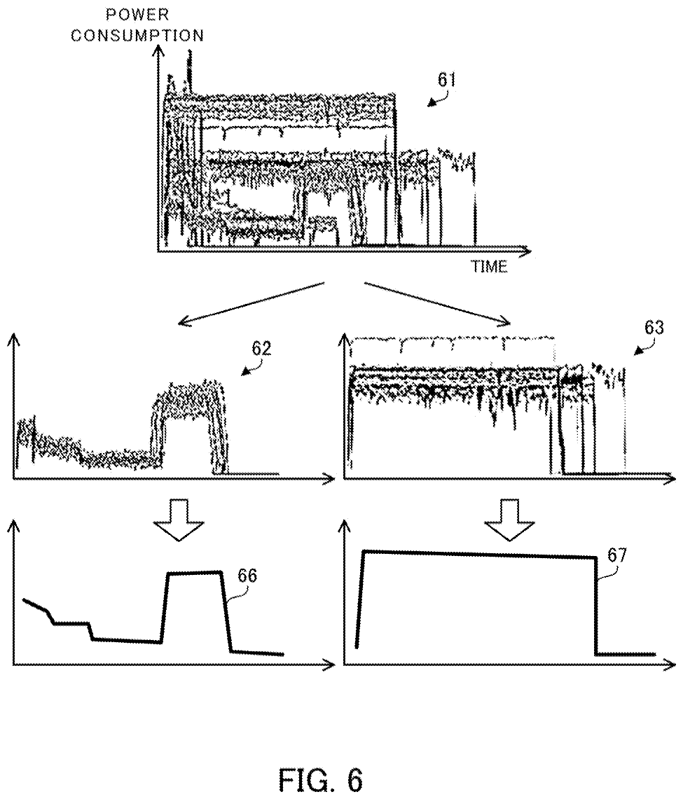

FIG. 6 illustrates an example of reducing training data by clustering.

A sample set 61 is a set of samples collected from the HPC system 31. Each sample of the sample set 61 represents temporal changes in the power consumption of a job. The sample set 61 includes samples of jobs with different execution times. The machine learning apparatus 100 divides the sample set 61 into a plurality of clusters each including two or more samples, according to a clustering algorithm. For example, the k-means algorithm is used as the clustering algorithm. It is expected that the clustering is performed so as to classify samples indicating similar temporal changes in power consumption into the same cluster. It is also expected that the clustering classifies samples of jobs with greatly different execution times into different clusters.

Here, the machine learning apparatus 100 divides the sample set 61 into a plurality of clusters including clusters 62 and 63. Then, with respect to each cluster, the machine learning apparatus 100 extracts one representative sample that is a representative of the two or more samples belonging to the cluster. The representative sample of a cluster is equivalent to the center of mass of the cluster. For example, the representative sample is an average sample calculated by averaging the measurement values at the individual time points represented by the samples belonging to the cluster. The average sample is an average vector that is obtained with taking a sequence of measurement values as a vector.

Here, the machine learning apparatus 100 extracts a representative sample 66 from the cluster 62 and a representative sample 67 from the cluster 63. The machine learning apparatus 100 uses a set of representative samples extracted from the individual clusters as training data. Here, the representative samples 66 and 67 are used as training data. By doing so, the training data including as many representative samples as the number of clusters is generated. Thus, the generated training data has low redundancy and is smaller in size than the sample set 61.

However, in the case where a general clustering algorithm such as the k-means algorithm is executed on samples including time-series data, some clusters may have a wide distribution of samples. A cluster with a wide distribution of samples is a cluster with a high variance of power consumption and contains samples that have low similarities in the temporal changes of power consumption. For example, the cluster 62 of FIG. 6 is a favorable cluster with high similarity among the samples, whereas the cluster 63 of FIG. 6 is an unfavorable cluster with low similarity among the samples.

If a representative sample is extracted from an unfavorable cluster with a wide distribution of samples, the representative sample would not sufficiently approximate the two or more samples belonging to the unfavorable cluster. As a result, training data including the representative sample has questionable quality, and accordingly a power consumption prediction model generated from the training data has low prediction accuracy. To deal with this, the machine learning apparatus 100 recursively performs clustering and evaluation of clusters to improve the quality of training data.

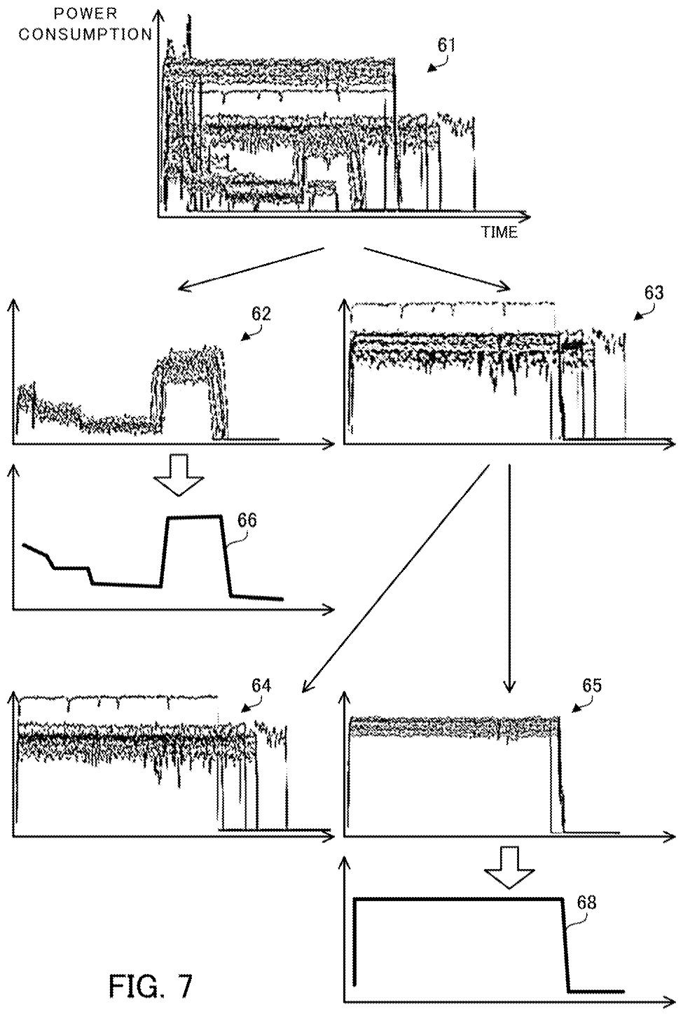

FIG. 7 illustrates an example of subdividing an unfavorable cluster.

The machine learning apparatus 100 divides the sample set 61 into the plurality of clusters including the clusters 62 and 63. Then, the machine learning apparatus 100 classifies each of the plurality of generated clusters as a favorable cluster with a narrow distribution of samples or an unfavorable cluster with a wide distribution of samples. The classification as a favorable cluster or unfavorable cluster is performed using an index based on the cross-correlations between the samples within the same cluster, as described later. A cluster having high correlations between samples is considered a favorable cluster, whereas a cluster having low correlations between samples is considered as an unfavorable cluster. Here, the machine learning apparatus 100 determines the cluster 62 as a favorable cluster and the cluster 63 as an unfavorable cluster.

In the case where one or more unfavorable clusters exist, the machine learning apparatus 100 performs, for each unfavorable cluster, clustering of the two or more samples belonging to the unfavorable cluster to subdivide the unfavorable cluster into a plurality of clusters. As a clustering algorithm for subdividing unfavorable clusters, a clustering algorithm that is the same as or different from that used for the clustering of the sample set 61 may be used. For example, the machine learning apparatus 100 divides the cluster 63 into a cluster 64 and a cluster 65 with the k-means algorithm. The samples of each cluster 64 and 65 after the subdivision are expected to have a narrower distribution than the samples of the original cluster 63.

The machine learning apparatus 100 classifies each of the plurality of recursively subdivided clusters as a favorable cluster with a narrow distribution of samples or an unfavorable cluster with a wide distribution of samples. Here, the machine learning apparatus 100 determines the cluster 64 as an unfavorable cluster and the cluster 65 as a favorable cluster. Then, the machine learning apparatus 100 extracts representative samples only from the favorable clusters and does not extract any representative samples from the unfavorable clusters. Here, the machine learning apparatus 100 extracts a representative sample 66 from the cluster 62 and a representative sample 68 from the cluster 65.

The representative sample 66 sufficiently approximates the two or more samples included in the cluster 62. The representative sample 68 sufficiently approximates the two or more samples included in the cluster 65. However, it is said that, even if a representative sample is extracted from the cluster 64, the representative sample does not sufficiently approximate the two or more samples included in the cluster 64. Therefore, no representative sample is extracted from the cluster 64. The machine learning apparatus 100 uses a set of the representative samples extracted from the plurality of favorable clusters as training data. Thus, the training data has an improved quality.

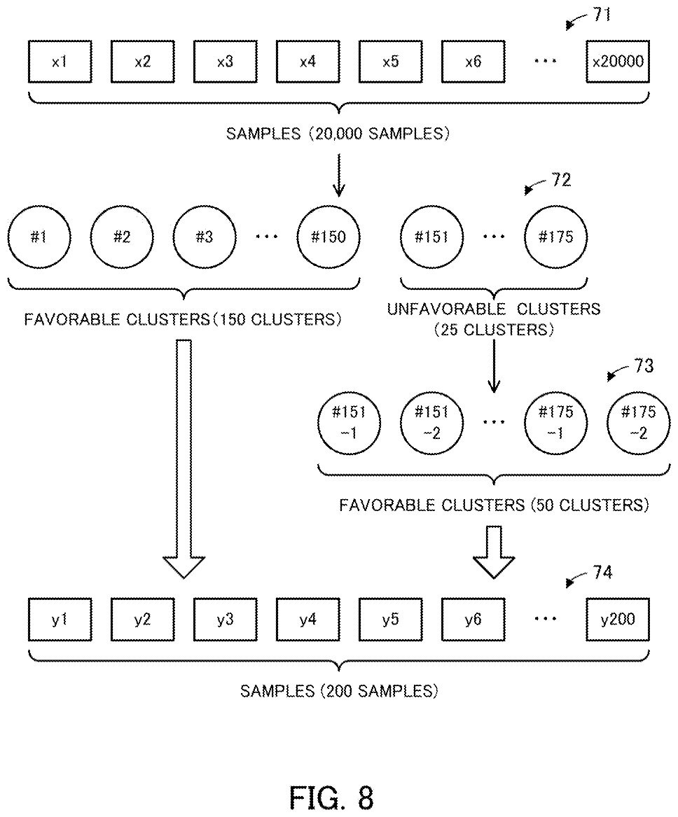

FIG. 8 illustrates an example of generating training data.

As an example, the machine learning apparatus 100 collects a sample set 71. The sample set 71 includes 20000 samples: samples x1, x2, . . . , x20000. Each sample indicates temporal changes in the power consumption of one job. The machine learning apparatus 100 performs first-stage clustering to generate a cluster set 72 from the sample set 71. For example, the machine learning apparatus 100 generates the cluster set 72 with the k-means algorithm. The cluster set 72 includes 175 clusters: clusters #1, #2, . . . , #175.

The machine learning apparatus 100 evaluates, with respect to each cluster included in the cluster set 72, the distribution of samples included in the cluster. The machine learning apparatus 100 classifies 150 clusters of the 175 clusters as favorable clusters and the remaining 25 clusters as unfavorable clusters. For example, the machine learning apparatus 100 classifies the clusters #1, #2, . . . , #150 as favorable clusters and the clusters #151, #152, . . . , #175 as unfavorable clusters.

The machine learning apparatus 100 performs the second-stage clustering to divide each of the 25 unfavorable clusters into half to generate a cluster set 73. For example, the machine learning apparatus 100 generates the cluster set 73 with the k-means algorithm. The cluster set 73 includes 50 clusters: clusters #151-1, #151-2, #152-1, #152-2, . . . , #175-1, and #175-2. The clusters #151-1 and #151-2 are generated from the cluster #151. The clusters #152-1 and #152-2 are generated from the cluster #152. The clusters #175-1 and #175-2 are generated from the cluster #175.

The machine learning apparatus 100 determines the clusters included in the cluster set 73 as favorable clusters. The machine learning apparatus 100 extracts a representative sample from each of the 150 favorable clusters included in the cluster set 72 and 50 favorable clusters included in the cluster set 73. By doing so, the machine learning apparatus 100 generates training data 74. The training data 74 includes 200 samples: samples y1, y2, . . . , y200.

With the above approach, the size of the training data 74 is 1/100 as small as that of the sample set 71. In addition, the training data 74 has less redundancy than the sample set 71 and includes samples with a variety of power consumption patterns. Still further, each sample in the training data 74 approximates a subset of the sample set 71.

The following describes how to determine a cluster as a favorable cluster or an unfavorable cluster.

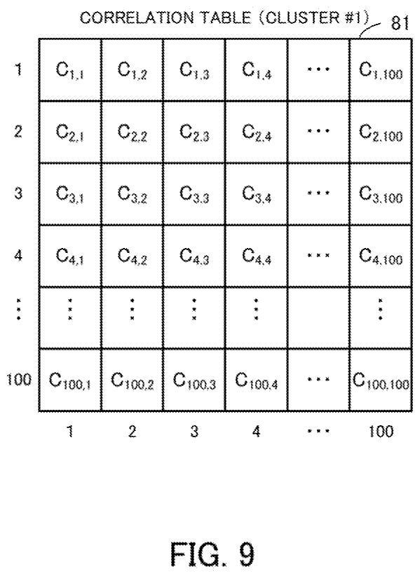

FIG. 9 illustrates an example of a correlation table.

The machine learning apparatus 100 creates a correlation table 81 for each cluster. Assume now that a cluster #1 includes 100 samples and the machine learning apparatus 100 determines whether the cluster #1 is favorable or unfavorable. The correlation table 81 for the cluster #1 is a matrix with 100 rows and 100 columns. These rows and columns correspond to 100 samples. The machine learning apparatus 100 calculates, for every pair of samples among the 100 samples included in the cluster #1, a correlation value indicating a correlation in power consumption between the paired samples. The correlation table 81 includes 10000 correlation values exhaustively calculated between the 100 samples. The correlation value between the i-th sample and the j-th sample is stored in the i-th row and j-th column of the correlation table 81.

The correlation value between two time-series signals is calculated based on the cross-correlation therebetween. In general, the cross-correlation between two time-series signals is defined by the equation (2), where f denotes one time-series signal, g denotes the other time-series signal, m denotes an index indicating a time, and n denotes a shift amount (delay amount) of the time-series signal g to be compared with the time-series signal f. The cross-correlation is defined as a function of the shift amount n. In view of this, in the second embodiment, the similarity between the power consumption signals of two jobs is evaluated with the execution start times of the jobs aligned. Therefore, the machine learning apparatus 100 calculates the cross-correlation at the time point of n=0 as a correlation value. Thus, the correlation value between two samples is calculated by the equation (3).

$$\begin{matrix}( f * g ) [ n ] = {\sum }_{m = - ∞}^{∞} \overline{f [ m ]} g [ m + n ] & ( 2 ) \\ ( f * g ) [ 0 ] = {\sum }_{m = - ∞}^{∞} \overline{f [ m ]} g [ m ] & ( 3 )\end{matrix}$$

The correlation table 81 represents the distribution of the correlation values between the 100 samples included in the cluster #1. The machine learning apparatus 100 calculates index values indicating the width of the distribution of the samples included in the cluster #1 from the 10000 correlation values included in the correlation table 81. The index values are the standard deviation of the correlation values and the average of the correlation values.

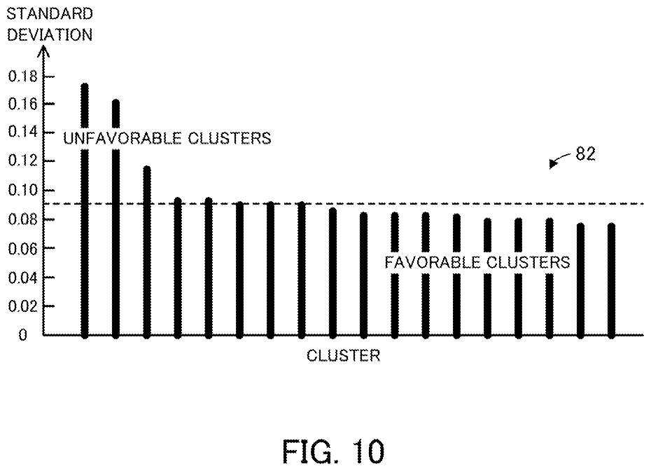

FIG. 10 is a graph representing an example of classification of clusters based on the standard deviation of correlation values.

The machine learning apparatus 100 calculates the standard deviation of correlation values for each cluster and sorts the plurality of clusters in descending order of the standard deviation. The graph 82 represents the standard deviations of the correlation values with respect to 18 clusters. The machine learning apparatus 100 compares the standard deviation of each cluster with a threshold. The machine learning apparatus 100 determines clusters having standard deviations greater than or equal to the threshold as unfavorable clusters. On the other hand, the machine learning apparatus 100 determines, as favorable clusters, clusters having standard deviations less than the threshold and satisfying an average criterion described later.

In FIG. 10, the threshold for the standard deviation is 0.09. A fixed value may be set in advance as the threshold for the standard deviation. Alternatively, a user-specified value may be set as the threshold for the standard deviation. In addition, in the case where the number of unfavorable clusters (for example, 25) or the ratio of unfavorable clusters is given, the machine learning apparatus 100 may dynamically determine the threshold so as to satisfy the number or ratio of unfavorable clusters.

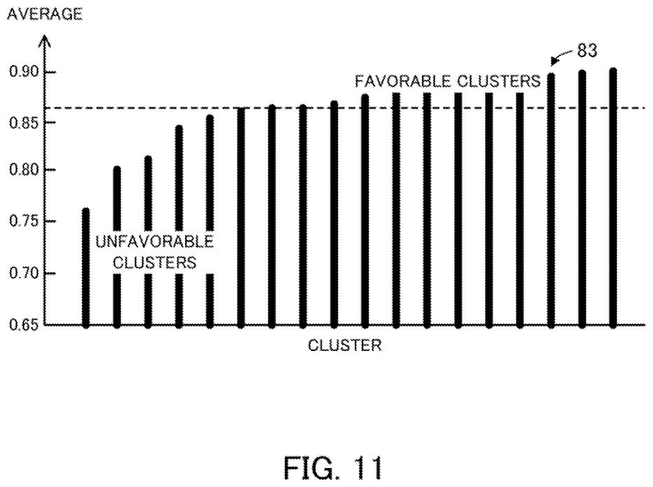

FIG. 11 is a graph representing an example of classification of clusters based on the average of correlation values.

The machine learning apparatus 100 calculates the average of correlation values for each cluster and sorts the plurality of clusters in ascending order of the average. The graph 83 represents the average of correlation values with respect to 18 clusters. The machine learning apparatus 100 compares the average of each cluster with a threshold. The machine learning apparatus 100 determines clusters having averages lower than or equal to the threshold as unfavorable clusters. In addition, the machine learning apparatus 100 determines, as favorable clusters, clusters having the averages exceeding the threshold and satisfying the standard-deviation criterion described above with reference to FIG. 10.

In FIG. 11, the threshold for the average is 0.86. A fixed value may be set in advance as the threshold for the average. Alternatively, a user-specified value may be set as the threshold. In addition, in the case where the number of unfavorable clusters (for example, 25) or the ratio of unfavorable clusters is given, the machine learning apparatus 100 may dynamically determine the threshold so as to satisfy the number or ratio of unfavorable clusters.

In this connection, in the second embodiment, the machine learning apparatus 100 uses the standard-deviation criterion and average criterion as AND condition, and determines clusters whose standard deviations are less than the threshold and whose averages exceed the threshold as favorable clusters. Alternatively, using the standard-deviation criterion and the average criterion as OR condition, the machine learning apparatus 100 may determine clusters whose standard deviations are less than the threshold or whose averages exceed the threshold as favorable clusters. Yet alternatively, the machine learning apparatus 100 may classify clusters only under the standard-deviation criterion or under the average criterion.

The following describes the functions and processing procedure of the machine learning apparatus 100.

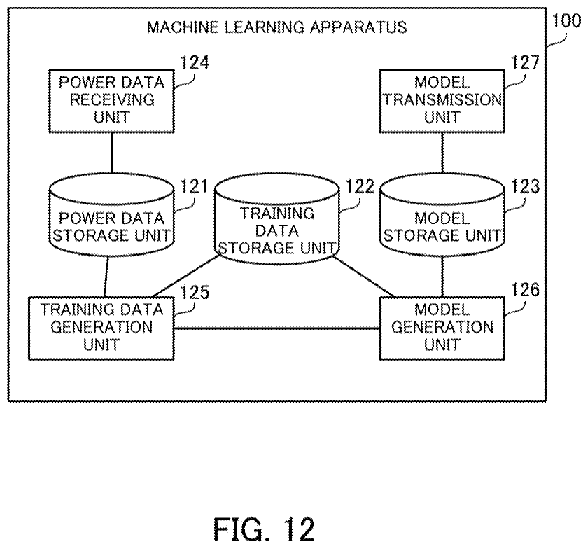

FIG. 12 is a block diagram illustrating an example of functions of the machine learning apparatus.

The machine learning apparatus 100 includes a power data storage unit 121, a training data storage unit 122, and a model storage unit 123. These storage units are implemented by using storage space in the RAM 102 or HDD 103, for example. In addition, the machine learning apparatus 100 includes a power data receiving unit 124, a training data generation unit 125, a model generation unit 126, and a model transmission unit 127. These processing units are implemented by programs, for example.

The power data storage unit 121 stores therein samples collected from the job scheduler 32 as power data. Each sample includes time-series measurement values of power consumption of a job. The training data storage unit 122 stores therein training data for use in machine learning. The model storage unit 123 stores a power consumption prediction model generated from the training data through the machine learning. The power consumption prediction model is a recurrent neural network.

The power data receiving unit 124 receives the samples from the job scheduler 32 and stores the received samples in the power data storage unit 121. The training data generation unit 125 analyzes the sample set stored in the power data storage unit 121 to generate the training data, and stores the generated training data in the training data storage unit 122. The number of samples in the training data, that is, the size of the training data is smaller than the size of the sample set stored in the power data storage unit 121. The training data is a dataset with less redundancy than the original sample set.

The model generation unit 126 generates the power consumption prediction model for predicting future power consumption of jobs from past power consumption of the jobs, using the training data stored in the training data storage unit 122. In the machine learning, the model generation unit 126 optimizes the values of parameters included in the recurrent neural network, using the samples included in the training data. In this connection, error backpropagation is used for the parameter optimization in the neural network. The model generation unit 126 stores the generated power consumption prediction model in the model storage unit 123.

The model transmission unit 127 sends the power consumption prediction model stored in the model storage unit 123 to the job scheduler 32. The job scheduler 32 then uses the power consumption prediction model to predict future power consumption of jobs under execution by the HPC system 31 and performs job scheduling so that the total power consumption does not exceed the contract demand.

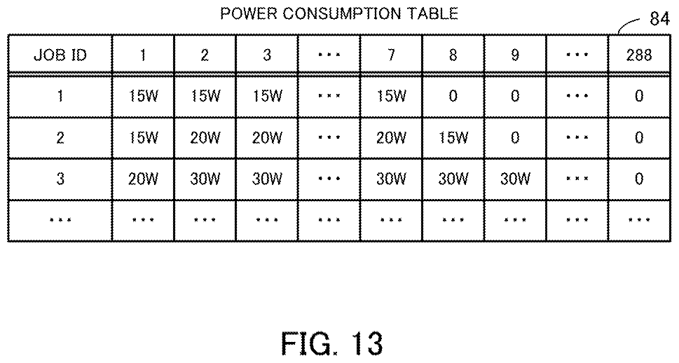

FIG. 13 illustrates an example of a power consumption table.

The power consumption table 84 is stored in the power data storage unit 121. One row in the power consumption table 84 corresponds to one sample. The power consumption table 84 contains a job ID and 288 measurement values of power consumption for each sample. A job ID is an identifier of a job. The power consumption of each job is measured every 5 minutes. The shortest execution time of the jobs is 35 minutes, and the longest execution time is 1440 minutes. Among the 288 measurement values, measurement values obtained after the execution of a job is completed are set to zero.

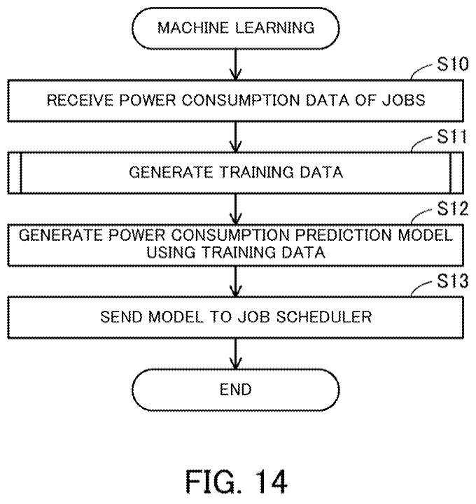

FIG. 14 is a flowchart illustrating an example of a procedure of the machine learning.

(S10) The power data receiving unit 124 receives power consumption data indicating temporal changes in the power consumption of jobs from the job scheduler 32.

(S11) The training data generation unit 125 generates training data from the power consumption data received at step S10. The generation of the training data will be described in detail later. In this connection, the training data generation unit 125 may display the training data on the display device 111 or may send the training data to another information processing apparatus.

(S12) The model generation unit 126 generates a power consumption prediction model through machine learning using the training data generated at step S11. In this connection, the model generation unit 126 may display the power consumption prediction model on the display device 111. In addition, the model generation unit 126 may calculate the prediction accuracy of the power consumption prediction model and display the prediction accuracy on the display device 111.

(S13) The model transmission unit 127 sends the power consumption prediction model generated at step S12 to the job scheduler 32.

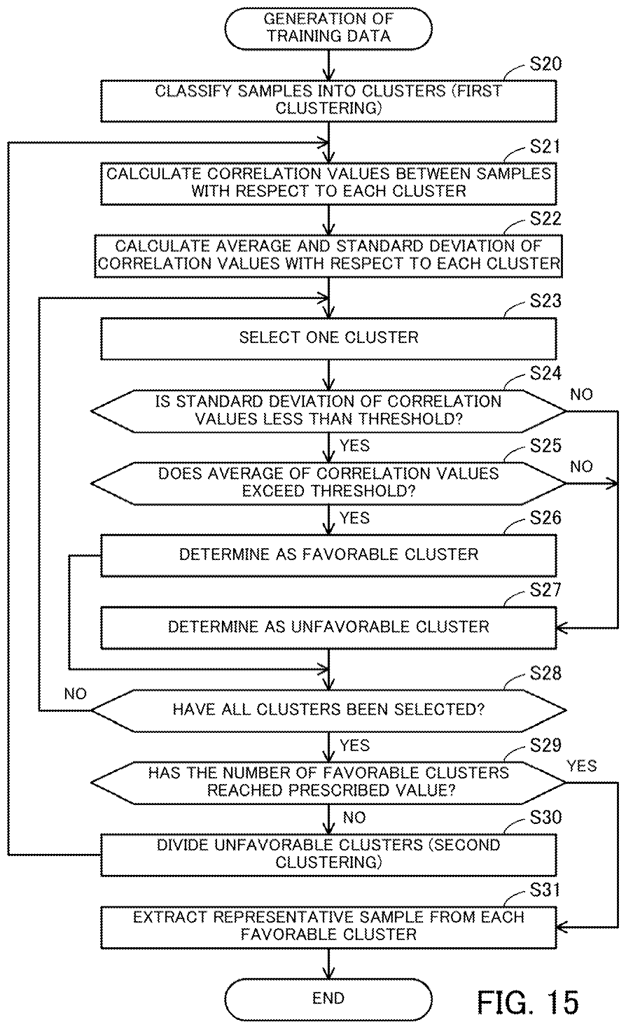

FIG. 15 is a flowchart illustrating an example of a procedure of generating training data.

Training data is generated at the above-described step S11.

(S20) The training data generation unit 125 classifies the samples of the power consumption data into a plurality of clusters with a clustering algorithm such as the k-means algorithm.

(S21) With respect to each cluster that is not yet evaluated, the training data generation unit 125 exhaustively calculates the correlation values between the samples belonging to the cluster and creates a correlation table 81.

(S22) With respect to each cluster that is not yet evaluated, the training data generation unit 125 calculates the average and standard deviation of correlation values with reference to the correlation table 81 created at step S21.

(S23) The training data generation unit 125 selects one of the clusters that are not yet evaluated.

(S24) With respect to the cluster selected at step S23, the training data generation unit 125 determines whether the standard deviation calculated at step S22 is less than a threshold. If the standard deviation is less than the threshold, the process proceeds to step S25. Otherwise, the process proceeds to step S27.

(S25) With respect to the cluster selected at step S23, the training data generation unit 125 determines whether the average calculated at step S22 exceeds a threshold. If the average exceeds the threshold, the process proceeds to step S26. Otherwise, the process proceeds to step S27.

(S26) The training data generation unit 125 determines the cluster selected at step S23 as a favorable cluster. Then, the process proceeds to step S28.

(S27) The training data generation unit 125 determines the cluster selected at step S23 as an unfavorable cluster. In this connection, in the second embodiment, the training data generation unit 125 determines a cluster having a standard deviation less than the threshold and an average exceeding the threshold as a favorable cluster. Alternatively, a different criterion may be used for the determination. For example, the training data generation unit 125 may determine a cluster having a standard deviation less than the threshold as a favorable cluster, may determine a cluster having an average exceeding the threshold as a favorable cluster, or may determine a cluster satisfying at least one of the above criteria as a favorable cluster.

(S28) The training data generation unit 125 determines whether all clusters have been selected at step S23. If all the clusters have been selected, the process proceeds to step S29. Otherwise, the process proceeds back to step S23.

(S29) The training data generation unit 125 determiners whether the number of favorable clusters has reached a prescribed value (for example, 200). The prescribed value is specified by the user, for example. If the prescribed value has been reached, the process proceeds to step S31. Otherwise, the process proceeds to step S30.

(S30) With respect to each of the unfavorable clusters, the training data generation unit 125 classifies the samples belonging to the unfavorable cluster into a plurality of clusters according to a clustering algorithm such as the k-means algorithm. Then, the process proceeds back to step S21.

(S31) The training data generation unit 125 extracts one representative sample from each favorable cluster. A representative sample is equivalent to the center of mass of a favorable cluster. For example, the training data generation unit 125 calculates, as a representative sample, an average vector with taking each sample as a vector of measurement values. The training data generation unit 125 generates training data including the plurality of representative samples corresponding to the plurality of favorable clusters.

The following describes an example of how the machine learning progresses. As described earlier with reference to FIG. 8, the machine learning apparatus 100 collects the 20000 samples and analyzes the sample set to generate the training data including 200 samples. A mini-batch size is 20. This means that the machine learning apparatus 100 uses 20 samples in each iteration. In each iteration, an error of the power consumption prediction model is calculated and the values of the parameters are updated. Since the training data contains 200 samples, the machine learning apparatus 100 executes the above iteration ten times while using different samples. The number of epochs is 50. That is, the machine learning apparatus 100 repeatedly executes 50 sets of 10 iterations using 200 samples.

For example, in the case where training data is generated with the method described with reference to FIG. 6 in the machine learning, the overall RMSE of the power consumption prediction model is 1.80. In addition, in the case where training data is generated with the improved method described with reference to FIG. 7, the overall RMSE of the power consumption prediction model is 1.68. This means that the error of the power consumption prediction model is reduced by 7%. The improvement in the prediction accuracy of the power consumption prediction model contributes to reducing the occurrence of an accident in which the total power consumption of the HPC system 31 exceeds the contract demand, contrary to the prediction. For example, the reduction of the error by 7% leads to decreasing the power consumption of the HPC system 31 by 54.4 MW per year. This results in reducing the electricity fee of the HPC system 31 charged to the owner by one million yen per year, for example.

In the information processing system of the second embodiment, a large number of samples regarding the power consumption of jobs are collected from the HPC system 31, but the size of training data is reduced. This reduces the loads of the machine learning and shortens the execution time of the machine learning. In addition, the sample set is divided into a plurality of clusters through clustering, and representative samples are extracted from the individual clusters and are used for generating training data. This approach reduces the redundancy in the training data, and efficiently reduces the size of the training data with keeping the quality of the training data.

In addition, it is determined whether each of the plurality of clusters obtained through the clustering is favorable or unfavorable, and clustering is recursively performed on the unfavorable clusters. Then, representative samples are extracted only from the individual favorable clusters. This reduces the possibility of extracting an inappropriate representative sample that is not said to sufficiently approximate a subset of the sample set, and thus improves the quality of the training data. As a result, the prediction accuracy of the power consumption prediction model is improved.

In addition, with respect to each cluster, the standard deviation and average of correlation values between samples are calculated, and the width of the distribution of the samples is evaluated based on the standard deviation and average of the correlation values. Therefore, it is possible to objectively and efficiently evaluate the cluster. In addition, the improvement of the prediction accuracy of the power consumption prediction model leads to predicting future total power consumption of the HPC system 31 with high accuracy. This reduces the occurrence of an accident in which the total power consumption exceeds the contract demand, thereby reducing the electricity fee of the HPC system 31.

According to one aspect, the quality of training data to be used for generating a power consumption prediction model is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory that stores therein a plurality of samples each including time-series measurement values of power consumption; and
a processor configured to perform a process including
performing first clustering on the plurality of samples to generate a plurality of first clusters each including two or more samples,
classifying each of the plurality of first clusters as a second cluster satisfying a determination condition or a third cluster that does not satisfy the determination condition, the determination condition including at least one of a first criterion in which a variance of correlation values between the two or more samples is less than a first threshold and a second criterion in which an average of the correlation values exceeds a second threshold,
performing second clustering on the two or more samples included in the third cluster to divide the third cluster into a plurality of fourth clusters, and
generating training data, based on the second cluster and at least one of the plurality of fourth clusters, the training data being used for generating a model for predicting the power consumption.

2. The information processing apparatus according to claim 1, wherein the determination condition includes both of the first criterion and the second criterion.

3. The information processing apparatus according to claim 1, wherein the classifying includes, with respect to each of the plurality of first clusters, calculating cross-correlations between the time-series measurement values for all pairs of samples as the correlation values and calculating at least one of the variance and the average of the cross-correlations.

4. The information processing apparatus according to claim 1, wherein the generating of the training data includes generating the training data using the second cluster and one or more fourth clusters satisfying the determination condition among the plurality of fourth clusters.

5. The information processing apparatus according to claim 1, wherein the generating of the training data includes extracting representative samples from respective ones of the second cluster and the at least one of the fourth clusters and generating the training data including the representative samples that are fewer than the plurality of samples.

6. The information processing apparatus according to claim 5, wherein each of the representative samples indicates an average of the time-series measurement values of samples included in a cluster from which the each of the representative samples is extracted.

7. The information processing apparatus according to claim 1, wherein the process further includes generating a neural network using, as input data, measurement values taken during a first time period and, as teaching data, measurement values taken during a second time period following the first time period, among the time-series measurement values of samples included in the training data, the neural network being used for predicting power consumption of the second time period from power consumption of the first time period.

8. An information processing method comprising:
obtaining, by a processor, a plurality of samples each including time-series measurement values of power consumption;
performing, by the processor, first clustering on the plurality of samples to generate a plurality of first clusters each including two or more samples;
classifying, by the processor, each of the plurality of first clusters as a second cluster satisfying a determination condition or a third cluster that does not satisfy the determination condition, the determination condition including at least one of a first criterion in which a variance of correlation values between the two or more samples is less than a first threshold and a second criterion in which an average of the correlation values exceeds a second threshold;
performing, by the processor, second clustering on the two or more samples included in the third cluster to divide the third cluster into a plurality of fourth clusters; and
generating, by the processor, training data, based on the second cluster and at least one of the plurality of fourth clusters, the training data being used for generating a model for predicting the power consumption.

9. A non-transitory computer-readable storage medium storing a program that causes a computer to perform a process comprising:
obtaining a plurality of samples each including time-series measurement values of power consumption;
performing first clustering on the plurality of samples to generate a plurality of first clusters each including two or more samples;
classifying each of the plurality of first clusters as a second cluster satisfying a determination condition or a third cluster that does not satisfy the determination condition, the determination condition including at least one of a first criterion in which a variance of correlation values between the two or more samples is less than a first threshold and a second criterion in which an average of the correlation values exceeds a second threshold;
performing second clustering on the two or more samples included in the third cluster to divide the third cluster into a plurality of fourth clusters; and
generating training data, based on the second cluster and at least one of the plurality of fourth clusters, the training data being used for generating a model for predicting the power consumption.
